(19) United States
(12) Patent Application Publication
(10) Pub. No.: US 2017/0198416 A1
(43) Pub. Date: Jul. 13, 2017

(54) METHODS AND SYSTEMS FOR RECOVERING CARBON FIBERS FROM OBJECTS

(71) Applicant: EAST CHINA UNIVERSITY OF SCIENCE AND TECHNOLOGY, Shanghai (CN)

(72) Inventors: Chongjun Zhao, Shanghai (CN); Youfu Huang, Shanghai (CN); Jianbo Dong, Shanghai (CN); Xiuzhen Qian, Shanghai (CN); Jinchao Zhang, Shanghai (CN)

(21) Appl. No.: 15/313,702

(22) PCT Filed: May 30, 2014
(86) PCT No.: PCT/CN2014/078983

§ 371 Date: Nov. 23, 2016

(51) Int. Cl. D01F 9/12; H05B 3/02; H05B 3/14; C08J 99/00

(52) U.S. Cl. CPC D01F 9/12; C08J 99/00; H05B 3/023; H05B 3/145; C08J 2363/00

(57) ABSTRACT

Disclosed herein are methods and systems for recovering carbon fibers from objects. The object may include carbon fibers and resin. The object may be contacted with an electric current to separate the carbon fibers from the resin.

### BACKGROUND

Unless otherwise indicated herein, the materials described in this section are not prior art to the claims in this application and are not admitted to be prior art by inclusion in this section.

Current methods for recovering carbon fibers from carbon fiber reinforced polymers (CFRP) waste generally include mechanical pulverization, chemical solvent treatment, pyrolysis, treatment with supercritical fluids, or exposure to microwave. Each of these methods have its own shortcomings. For example, the mechanical pulverization method may result in a mixed debris of polymers and randomly ordered carbon fibers, which may be of low value for recovery. The supercritical fluid method, microwave method and pyrolysis method may all require specialized high pressure or temperature resistant devices, and the use of these methods can significantly increase the cost of carbon fiber recovery. The chemical solvent method would leave a large amount of organic solvent waste or nitric acid waste with dissolved polymers after the treatment, producing significant “secondary pollution” which can be difficult to dispose. Moreover, the above-mentioned methods have varying degrees of complexity in their operating procedures.

During the process of carbon fiber recovery, many of the existing methods as described above require external sources of heating. The external heating can be achieved by applying heat external to the CFRP sample, either directly to the CFRP sample or through a heated medium (solvent or hot air) external to the CFRP sample. The external heating typically causes uneven heating of the CFRP sample which can overheat outer surfaces of the CFRP sample and damage the carbon fibers that are recovered. Particularly for large and thick samples, they may require a longer processing time and may result in the carbon fibers in the outer portions of the CFRP sample to be burnt while the internal portions of the sample have not been completely treated. A prolonged heat treatment may significantly reduce the performance of carbon fibers. Another disadvantage of the above methods is that the order of arrangement of the carbon fibers obtained from the treatment may easily be disrupted, which is not conducive to the re-processing and re-use of the carbon fibers. The performance of the recovered carbon fibers can be greatly improved if they are well-ordered. There is therefore a need for an effective and simple method for recovering well-ordered carbon fibers from carbon fiber-containing objects, such as CFRP.

### SUMMARY

In one aspect, a method of recovering carbon fibers from at least one object includes: providing at least one object containing carbon fibers and resin; and contacting the at least one object with an electric current to separate the carbon fibers from the resin.

In another aspect, a system for recovering carbon fibers from at least one object includes: an electrical circuit configured to contact at least one object with an electric current, the object containing carbon fibers and resin, wherein the electric current separates the carbon fibers from the resin.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through use of the accompanying drawings.

FIG. 1 shows a schematic diagram illustrating a non-limiting embodiment of the electric heating method for recovering carbon fibers in CFRP.

FIGS. 2A and 2B show a setup diagram illustrating a non-limiting embodiment of the electric heating system for recovering carbon fibers in CFRP. FIG. 2A shows a top view of the electric heating system; and FIG. 2B shows a side view of the electric heating system.

FIGS. 3A and 3B show carbon fibers before and after recovery using a non-limiting embodiment of the electric heating method for recovering carbon fibers in CFRP, with a treatment voltage of 10 V and current of 14 A for 15 minutes. FIG. 3A shows a digital photograph of the CFRPs before the treatment; and FIG. 3B shows a digital photograph of carbon fibers obtained after the treatment.

FIGS. 4A and 4B show carbon fibers before and after recovery using a non-limiting embodiment of the electric heating method for recovering carbon fibers in CFRP, with a treatment voltage of 12 V and current of 15 A for 5 minutes. FIG. 4A shows a digital photograph of the CFRPs before the treatment; and FIG. 4B shows a digital photograph of carbon fibers obtained after the treatment.

FIGS. 5A and 5B show carbon fibers before and after recovery using a non-limiting embodiment of the electric heating method for recovering carbon fibers with treatment voltage of 10 V and current of 17 A for 30 minutes. FIG. 5A shows a digital photograph of the CFRPs before the treatment; and FIG. 5B shows a digital photograph of carbon fibers obtained after the treatment.

FIGS. 6A and 6B show scanning electron microscope (SEM) images of carbon fibers recovered using a non-limiting embodiment of the electric heating method for recovering carbon fibers in CFRP after treatment with a voltage of 10 V and a current of 17 A for 30 minutes. FIG. 6A shows the image of the carbon fibers at a magnification of 10,000 times; and FIG. 6B shows the image of the carbon fibers at a magnification of 5000 times.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

Carbon fibers generally have good electrical conductivity, and may usually be distributed uniformly throughout a resin matrix of CFRPs. Taking advantage of such properties, some embodiments disclosed herein provide methods of recovering carbon fibers from a carbon fiber-containing object, such as a CFRP, through an “internal heating approach”. The “internal heating approach” can be achieved by passing an electric current through the carbon fibers to generate heat internally within the carbon fibers. Heat from the carbon fibers can then soften the surrounding resin matrix and separate the carbon fibers from the polymer matrix.

As described herein, the “internal heating approach” can effectively treat carbon fiber-containing objects, such as CFRPs, to obtain clean and well-ordered carbon fibers with properties that are substantially the same as the original carbon fibers before they were processed into CFRPs. For example, the surface of the obtained carbon fibers can be substantially as smooth as the original carbon fibers. In some embodiments, the surface of the obtained carbon fibers can be substantially free of damage. In some embodiments, the obtained carbon fibers are substantially well-ordered. In some embodiments, the obtained carbon fibers have substantially the same order of arrangement as the original carbon fibers. The methods disclosed herein can also be simple to operate and have minimal equipment requirements.

### Methods of Recovering Carbon Fibers

Methods of recovering carbon fibers from at least one carbon fiber-containing object are provided herein. The carbon fiber-containing object may include carbon fibers and resin. In some embodiments, the method includes providing at least one object that includes carbon fibers and resin; and contacting the at least one object with an electric current to separate the carbon fibers from the resin. It will be appreciated that the carbon fibers can be recovered using only the providing and contacting steps, and can exclude other steps such as contacting the CFRP with one or more solvents, mechanical shearing or chopping the CFRP, and/or applying external heat to the CFRP. In some embodiments, the method consists of the providing and contacting steps. In some embodiments, the method consists essentially of the providing and contacting steps.

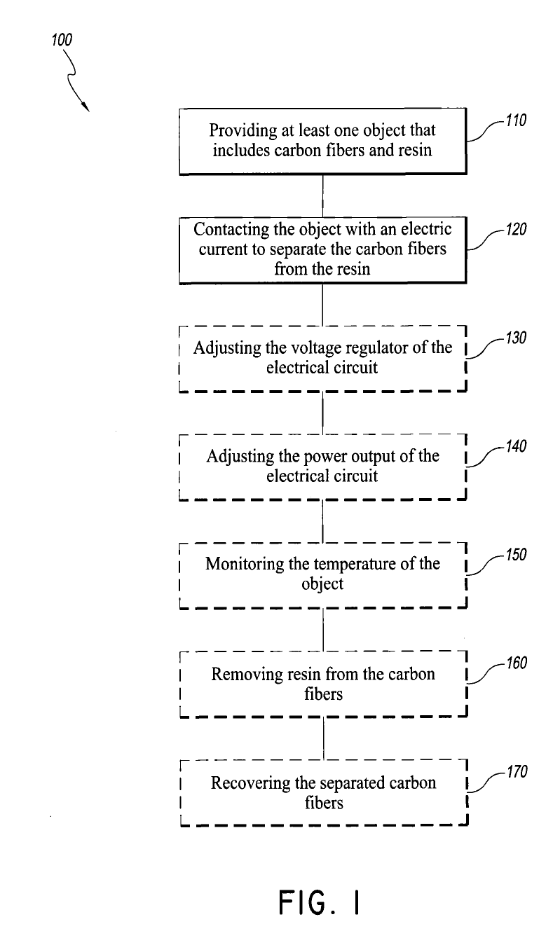

A non-limiting example of the method 100 of recovering carbon fibers in accordance with the disclosed embodiments is illustrated in the flow diagram shown in FIG. 1. As illustrated in FIG. 1, the method 100 can include one or more functions, operations or actions as illustrated by one or more operations 110-170.

Method 100 can begin at operation 110, “Providing at least one object that includes carbon fibers and resin.” Operation 110 can be followed by operation 120, “Contacting the object with an electric current to separate the carbon fibers from the resin.” Operation 120 can be followed by optional operation 130, “Adjusting the voltage regulator of the electrical circuit.” Operation 130 can be followed by optional operation 140, “Adjusting the power output of the electrical circuit.” Operation 140 can be followed by optional operation 150, “Monitoring the temperature of the object.” Operation 150 can be followed by optional operation 160, “Removing resin from the carbon fibers.” Operation 160 can be followed by optional operation 170, “Recovering the separated carbon fibers.”

In FIG. 1, operations 110-170 are illustrated as being performed sequentially with operation 110 first and operation 170 last. It will be appreciated, however, that these operations can be combined and/or divided into additional or different operations as appropriate to suit particular embodiments. For example, additional operations can be added before, during or after one or more operations 110-170. In some embodiments, one or more of the operations can be performed at about the same time. In some embodiments, the method only consists of operations 110 and 120, but not any other operations. In some embodiments, the method consists essentially of operations 110 and 120. In some embodiments, the method only consists of operations 110, 120 and one of operations 130-170, but not any other operations. In some embodiments, the method only consists of operations 110, 120 and two of operations 130-170, but not any other operations. In some embodiments, the method only consists of operations 110, 120 and one or more of operations 130-170, but not any other operations.

At operation 110, “Providing at least one object that includes carbon fibers and resin,” the object is not particularly limited and can be CFRPs. The size of the CFRP is not particularly limited. For example, the object can include a CFRP having a length of about 1 cm to about 1 m or more, and a width of about 1 cm to about 1 m or more. In some embodiments, the object can include a small piece of CFRP. The size of the small piece of CFRP can be less than or equal to about 30 cm by 1 cm, for example less than or equal to 14 cm by 3 cm. In some embodiments, the object can include a large piece of CFRP. The size of the large piece of CFRP can be greater than or equal to about 1 m by 1 m. In some embodiments, the object has a thickness of about 1 mm to about 10 cm or more. In some embodiments, the object has a thickness of about 1 mm, about 2 mm, about 3 mm, about 4 mm, about 5 mm, about 6 mm, about 7 mm, about 8 mm, about 9 mm, about 1 cm, about 2 cm, about 3 cm, about 4 cm, about 5 cm, about 6 cm, about 7 cm, about 8 cm, about 9 cm, about 10 cm, or a thickness between any two of these values. In some embodiments, the object has a thickness of about 1 mm to about 3 mm The type of the resin can also vary. In some embodiments, the resin is a thermoset resin or a thermoplastic polymer. Non-limiting examples of the resin include epoxy, polyester, vinyl ester, nylon, phenolic resin, and urea resin. The object may further include other components, such as aramid fiber, aluminum fiber, glass fiber, or any combination thereof.

At operation 120, “Contacting the object with an electric current to separate the carbon fibers from the resin,” contacting the object with the electric current can be performed, for example in the absence of a solvent. In some embodiments, contacting the object with the electric current is performed in the absence of a solvent. In some embodiments, contacting the object with the electrical current is performed in the absence of one or both of mechanical shearing and chopping. Contacting of the object with the electric current can generate heat within the object. In some embodiments, contacting the object with the electric current generates heat within the carbon fibers of the object. In some embodiments, contacting the object with the electric current generates heat within the resin of the object. In some embodiments, the heat is evenly distributed within the object. In some embodiments, no heat is applied to the object from an external source. The external source can be a heated medium, such as a solvent or a gas, external to the object. In some embodiments, the solvent is a chemical solvent. In some embodiments, the gas is air.

The amount of time for which the object is contacted with the electric current is not particularly limited. For example the electric current can heat the object for at least about 3 minutes. In some embodiments, the electric current can heat the object for about 1 minute to about 60 minutes or more. For example, the electric current can heat the object for about 1 minute, about 2 minutes, about 3 minutes, about 4 minutes, about 5 minutes, about 6 minutes, about 7 minutes, about 8 minutes, about 9 minutes, about 10 minutes, about 15 minutes, about 20 minutes, about 30 minutes, about 60 minutes, or an amount of time between any two of these values. In some embodiments, the electric current can heat the object for less than or equal to about 10 minutes or 5 minutes. In some embodiments, the electric current can heat the object for less than or equal to about 1 minute.

In some embodiments, the electric current can heat the object for about 5 minutes to about 30 minutes. In some embodiments, the electric current heats the object until the resin has been completely separated from the carbon fibers.

The source from which the electric current is produced is not particularly limited. In some embodiments, the electric current is provided by an electrical circuit. In some embodiments, the electrical circuit includes a voltage regulator. A voltage regulator typically receives a supply voltage and provides a regulated (for example, substantially constant) output voltage to an electrical circuit. The type of voltage regulator is not particularly limited. Any suitable voltage regulator can be used for the electrical circuit, for example, a simple voltage regulator, a feedback voltage regulator, an electromechanical voltage regulator, a coil-rotation AC voltage regulator, an AC voltage stabilizer, a DC voltage stabilizer, a linear regulator, a switching regulator, a silicon-controlled rectifier (SCR) regulator, or a combination thereof. In some embodiments, the voltage regulator is a low voltage regulator. The low voltage regulator, for example, is configured to regulate a supply voltage of about 1V to about 50V. In some embodiments, the low voltage regulator is configured to regulate a supply voltage of about 4V to about 12V. In some embodiments, the electrical circuit includes a power source. In some embodiments, the electrical circuit includes at least two electrodes that are connected to at least two contact points on the object.

In some embodiments, contacting the object with the electric current can include connecting at least two electrodes of an electrical circuit to at least two contact points on the object. In some embodiments, the at least two electrodes can be connected to the at least two contact points on the object directly. In some embodiments, the at least two electrodes are connected to the at least two contact points on the object through one or more electrical circuit clamps. In some embodiments, the at least two electrodes are connected to the at least two contact points on the object through a conductive foil, such as a metal foil.

Non-limiting examples of the metal foil include a copper foil, an aluminum foil or any combination thereof. Once connected, the electrical circuit is turned on. The current in the electrical circuit, as well as the treatment time, can be controlled by adjusting a voltage of the electrical circuit, for example through a voltage regulator. In some embodiments, contacting the object with the electric current can include applying a voltage of about 4 V to about 12 V across at least two contact points on the object. In some embodiments, contacting the object with the electric current can include supplying a power of about 50 W to about 200 W to an electrical circuit in electrical communication with the object.

The magnitude of the electric current produced from the electrical circuit is not particularly limited. For example, the electric current can have a current of about 1 A to about 200 A or more. In some embodiments, the electric current can have a current of about 1 A, about 2 A, about 3 A, about 4 A, about 5 A, about 6 A, about 7 A, about 8 A, about 9 A, about 10 A, about 11 A, about 12 A, about 13 A, about 14 A, about 15 A, about 16 A, about 17 A, about 18 A, about 19 A, about 20 A, about 30 A, about 40 A, about 50 A, about 60 A, about 70 A, about 80 A, about 90 A, about 100 A, about 200 A, or a current between any two of these values. In some embodiments, the electric current can have a current of about 14 A to about 20 A. In some embodiments, the electric current is an AC current. In some embodiments, the electric current is a DC current.

In some embodiments, the method can consist essentially of operation 110, “Providing at least one object that includes carbon fibers and resin,” and operation 120, “Contacting the object with an electric current to separate the carbon fibers from the resin.”

In some embodiments, the method can consist of operation 110, “Providing at least one object that includes carbon fibers and resin,” and operation 120, “Contacting the object with an electric current to separate the carbon fibers from the resin.”

At optional operation 130, “Adjusting the voltage regulator of the electrical circuit,” a voltage regulator can be used to control the voltage applied across at least two contact points on the object and hence the electric current passing through the object. The voltage applied is not particularly limited. For example, contacting the object with the electric current can include applying a voltage of about 1 V to about 240 V or more across at least two contact points on the object. In some embodiments, contacting the object with the electric current can include applying a voltage of about 1 V, about 2 V, about 3 V, about 4 V, about 5 V, about 6 V, about 7 V, about 8 V, about 9 V, about 10 V, about 11 V, about 12 V, about 13 V, about 14 V, about 15 V, about 16 V, about 17 V, about 18 V, about 19 V, about 20 V, about 30 V, about 40 V, about 50 V, about 60 V, about 70 V, about 80 V, about 90 V, about 100 V, about 200 V, about 240 V, or a voltage between any two of these values across at least two contact points on the object. In some embodiments, contacting the object with the electric current can include applying a voltage of about 4 V to about 12 V across at least two contact points on the object.

At optional operation 140, “Adjusting the power output of the electrical circuit,” the power supplied to the electrical circuit can vary. For example, the power can be at least about 10 watts (W). In some embodiments, contacting the object with the electric current includes supplying a power of about 10 W to about 10000 W or more. For example, the electrical circuit can be supplied with a power of about 10 W, about 20 W, about 30 W, about 40 W, about 50 W, about 60 W, about 70 W, about 80 W, about 90 W, about 100 W, about 110 W, about 120 W, about 140 W, about 160 W, about 180 W, about 200 W, about 500 W, about 1000 W, about 2000 W, about 3000 W, about 4000 W, about 5000 W, about 6000 W, about 7000 W, about 8000 W, about 9000 W, about 10000 W, or a power between any two of these values. In some embodiments, contacting the object with the electric current includes supplying a power of about 50 W to about 200 W.

At optional operation 150, “Monitoring the temperature of the object,” the temperature of the object may be monitored using a variety of techniques known in the art. For example, an infrared thermometer can be used to monitor the temperature of the object.

In some embodiments, the electric current can generate heat within the carbon fibers of the object to a certain temperature. Without being bound by theory, the electric current heats the object due to the electrical conductivity of the carbon fibers of the object. In some embodiments, the temperature can be regulated by the power of the electrical circuit. In some embodiments, the temperature can be regulated by adjusting the voltage of the electrical circuit. In some embodiments, the temperature can be regulated by the current of the electrical circuit. In some embodiments, the temperature of the object is achieved by adjusting the power, voltage, current, or a combination of the electrical circuit. In some embodiments, adjusting the voltage of the electrical circuit includes adjusting the voltage regulator. In some embodiments, the temperature of the object is kept constant through the contacting of the object with the electrical current. In some embodiments, the temperature of the object is changed during the contacting of the object with the electrical current.

The temperature of the object resulting from internal heating of the carbon fibers by the electric current is not particularly limited. For example, the electric current heats the object to a temperature of about 300° C. to about 600° C. or higher. In some embodiments, the electric current heats the object to a temperature of about 300° C., about 320° C., about 350° C., about 400° C., about 450° C., about 500° C., about 550° C., about 560 ° C., about 600° C., or a temperature between any two of these values. In some embodiments, the electric current heats the object to a temperature of at least about 300° C., at least about 350° C., at least about 400° C., at least about 450° C., at least about 500° C., at least about 550 ° C., or at least about 600° C. or higher. In some embodiments, the electric current heats the object to a temperature of about 320° C. to about 560° C.

At optional operation 160, “Removing resin from the carbon fibers,” the resin can be removed from the carbon fibers by hot airflow. Non-limiting examples of the resin includes an epoxy, polyester, vinyl ester, nylon, phenolic resin, and urea resin.

The methods disclosed herein can also include, in some embodiments, optional operation 170, “Recovering the separated carbon fibers.” In some embodiments, the carbon fibers are fully separated from the resin after the contacting step. In some embodiments, the carbon fibers substantially maintain the original order of arrangement of the carbon fibers after the contacting step. In some embodiments, the recovered carbon fibers can be collected by using a smooth plate. In some embodiments, the size of the plate can be larger than the object. The size of the recovered carbon fiber pieces is not particularly limited. For example, the size of the recovered carbon fiber pieces can be about 1 cm to about 30 cm. In some embodiments, the size of the recovered carbon fiber pieces can be about 1 cm, about 2 cm, about 3 cm, about 4 cm, about 5 cm, about 6 cm, about 7 cm, about 8 cm, about 9 cm, about 10 cm, about 11 cm, about 12 cm, about 13 cm, about 14 cm, about 15 cm, about 16 cm, about 17 cm, about 18 cm, about 19 cm, about 20 cm, about 25 cm, about 30 cm, or a size between any two of these values. In some embodiments, the size of the recovered carbon fiber pieces can be greater than about 30 cm.

### Systems for Recovering Carbon Fibers

Systems for recovering carbon fibers are disclosed herein. In some embodiments, the system includes an electrical circuit configured to contact an object with an electric current, the object including carbon fibers and resin, wherein the electric current separates the carbon fibers from the resin. In some embodiments, the electrical circuit includes at least two electrodes configured to electrically connect to at least two contact points on the object. In some embodiments, the electrical circuit includes a power source. In some embodiments, the electrical circuit includes a voltage regulator. In some embodiments, the voltage regulator is a low voltage regulator. In some embodiments, the electrical circuit includes a switch. In some embodiments, the two electrodes are connected to the two contact points on the object through a conductive foil, such as a copper foil, an aluminum foil or both. In some embodiments, the electric current source can be configured to contact the object with the electric current in the absence of a solvent.

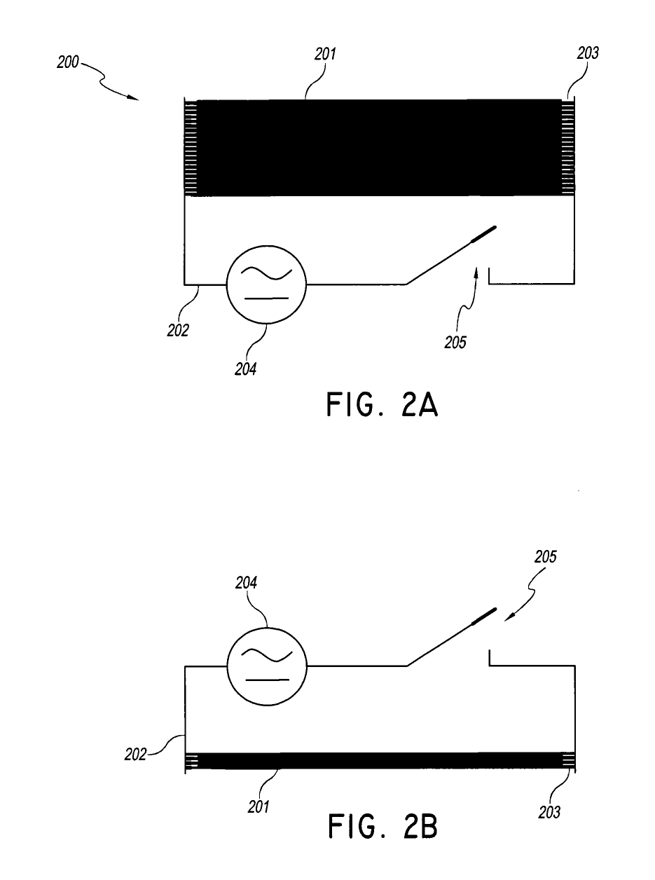

A non-limiting example of the system 200 for recovering carbon fibers in accordance with the present disclosure is illustrated in FIG. 2. As illustrated in

FIG. 2, the system 200 can include one or more components as illustrated by 201-205.

The object 201 including carbon fibers and resin is not particularly limited. In some embodiments, the object can include CFRPs. The size of the CFRP is not particularly limited. For example, the object can include a CFRP having a length of about 1 cm to about 1 m or more, and a width of about 1 cm to about 1 m or more. In some embodiments, the object can include a small piece of CFRP. The size of the small piece of CFRP can be less than or equal to about 30 cm by 1 cm, for example less than or equal to about 14 cm by 3 cm. In some embodiments, the object can include a large piece of CFRP. The size of the large piece of CFRP can be greater than or equal to about 1 m by 1 m. In some embodiments, the object has a thickness of about 1 mm to about 10 cm or more. In some embodiments, the object has a thickness of about 1 mm, about 2 mm, about 3 mm, about 4 mm, about 5 mm, about 6 mm, about 7 mm, about 8 mm, about 9 mm, about 1 cm, about 2 cm, about 3 cm, about 4 cm, about 5 cm, about 6 cm, about 7 cm, about 8 cm, about 9 cm, about 10 cm, or a thickness between any two of these values. In some embodiments, the object has a thickness of about 1 mm to about 3 mm In some embodiments, the resin is a thermoset resin or a thermoplastic polymer. Non-limiting examples of the resin include epoxy, polyester, vinyl ester, nylon, phenolic resin, and urea resin. The object including carbon fibers and resin may include other components, such as aramid fiber, aluminum fiber, glass fiber, or any combination thereof.

The source from which the electric current is produced is not particularly limited. In some embodiments, the electric current is provided by an electrical circuit 202.

In some embodiments, the electrical circuit 202 can include a voltage regulator. The type of voltage regulator is not particularly limited. Any suitable voltage regulator can be used for the electrical circuit, for example, a simple voltage regulator, a feedback voltage regulator, an electromechanical voltage regulator, a coil-rotation AC voltage regulator, an AC voltage stabilizer, a DC voltage stabilizer, a linear regulator, a switching regulator, a SCR regulator, etc., or a combination thereof. In some embodiments, the voltage regulator is a low voltage regulator.

In some embodiments, the electrical circuit 202 can include a power source 204. In some embodiments, the electrical circuit 202 can include a switch 205 for turning on or turning off the electrical circuit.

In some embodiments, the electrical circuit 202 can include two electrodes that are configured to connect to two contact points on the object 201. In some embodiments, the electrodes are configured to be connected to the two contact points on the object 201 directly. In some embodiments, the electrodes are configured to be connected to the object 201 through a conductive foil 203. The conductive foil can be, for example, a copper foil, an aluminum foil, or both.

The voltage of the electric current produced from the electrical circuit 202 is not particularly limited. For example, the electrical circuit 202 is configured to apply a voltage of about 1 V to about 240 V or more across at least two contact points on the object. In some embodiments, the electrical circuit 202 is configured to apply a voltage of about 1 V, about 2 V, about 3 V, about 4 V, about 5 V, about 6 V, about 7 V, about 8 V, about 9 V, about 10 V, about 11 V, about 12 V, about 13 V, about 14 V, about 15 V, about 16 V, about 17 V, about 18 V, about 19 V, about 20 V, about 30 V, about 40 V, about 50 V, about 60 V, about 70 V, about 80 V, about 90 V, about 100 V, about 200 V, about 240 V, or a voltage between any two of these values across at least two contact points on the object. In some embodiments, the electrical circuit 202 is configured to apply a voltage of about 4 V to about 12 V across at least two contact points on the object.

The current of the electric current produced from the electrical circuit 202 is not particularly limited. For example, the electric current can have a current of about 1 A to about 200 A or more. In some embodiments, the electric current can have a current of about 1 A, about 2 A, about 3 A, about 4 A, about 5 A, about 6 A, about 7 A, about 8 A, about 9 A, about 10 A, about 11 A, about 12 A, about 13 A, about 14 A, about 15 A, about 16 A, about 17 A, about 18 A, about 19 A, about 20 A, about 30 A, about 40 A, about 50 A, about 60 A, about 70 A, about 80 A, about 90 A, about 100 A, about 200 A, or a current between any two of these values. In some embodiments, the electric current can have a current of about 14 A to about 20 A. In some embodiments, the electric current is an AC current. In some embodiments, the electric current is a DC current.

The amount of time for which the electric current can be configured to heat the object 201 is not particularly limited. For example, the object 201 can be heated by the electric current for at least about 3 minutes. In some embodiments, the object 201 can be heated by the electric current for about 1 minute to about 60 minutes or more. For example, the electric current can heat the object 201 for about 1 minute, about 2 minutes, about 3 minutes, about 4 minutes, about 5 minutes, about 6 minutes, about 7 minutes, about 8 minutes, about 9 minutes, about 10 minutes, about 15 minutes, about 20 minutes, about 30 minutes, about 60 minutes, or an amount of time between any two of these values. In some embodiments, the electric current can heat the object 201 for about 5 minutes. In some embodiments, the electric current can heat the object 201 for about 15 minutes. In some embodiments, the electric current can heat the object 201 for about 30 minutes.

The power source 204 from which the electric current is produced is not particularly limited. In some embodiments, the power source 204 can be an electric generator or an electric battery. In some embodiments, the power of the electric current produced from the power source 204 can vary. For example, the electrical circuit is configured to operate at a power of about 10 watts (W). In some embodiments, the electrical circuit is configured to operate at a power of about 10 W to about 10000 W or more. For example, in some embodiments, the electrical circuit is configured to operate at a power of about 10 W, about 20 W, about 30 W, about 40 W, about 50 W, about 60 W, about 70 W, about 80 W, about 90 W, about 100 W, about 110 W, about 120 W, about 140 W, about 160 W, about 180 W, about 200 W, about 500 W, about 1000 W, about 2000 W, about 3000 W, about 4000 W, about 5000 W, about 6000 W, about 7000 W, about 8000 W, about 9000 W, about 10000 W, or a power between any two of these values. In some embodiments, the electrical circuit is configured to operate at a power of about 50 W to about 200 W.

The temperature of the object 201 is not particularly limited. For example, the electric current is configured to heat the object 201 to a temperature of about 300° C. to about 600° C. or higher. In some embodiments, the electric current is configured to heat the object 201 to a temperature of about 300° C., about 320° C., about 350° C., about 400° C., about 450° C., about 500° C., about 550° C., about 560° C., about 600° C., or a temperature between any two of these values. In some embodiments, the electric current is configured to heat the object 201 to a temperature of at least about 300° C., at least about 350° C., at least about 400° C., at least about 450° C., at least about 500° C., at least about 550° C., or at least about 600° C. or higher. In some embodiments, the electric current is configured to heat the object 201 to a temperature of 320° C. to 560° C.

Some of the advantages of the carbon fiber recovering methods and systems disclosed herein are: (1) the initial investment cost is low as no special equipment or device is required; (2) the “internal heating approach” uses an inert atmosphere-like sealed environment formed by the CFRP itself, and therefore does not require addition of a protective atmosphere during the treatment as typically used in “external heating” approaches such as the pyrolysis technology; (3) the methods are simple with short treatment time, and no specialized skills are required to operate; (4) the carbon fibers recovered by the methods may be well-ordered or have substantially the same order of arrangement as the original carbon fibers, and the mechanical performance of the recovered carbon fibers is suitable for reprocessing and utilization; and (5) the “internal heating approach” can recover carbon fibers from both thick and thin pieces of CFRPs due to the uniform distribution of the carbon fibers in the resin matrix of the CFRP and the heat generated within each fiber when the electrical current passes through the fibers.

### EXAMPLES

Additional embodiments are disclosed in further detail in the following examples, which are not in any way intended to limit the scope of the claims.

### Example 1

### Recovering Carbon Fibers Using Treatment With 10 V Voltage and 14 A Current for 15 Minutes

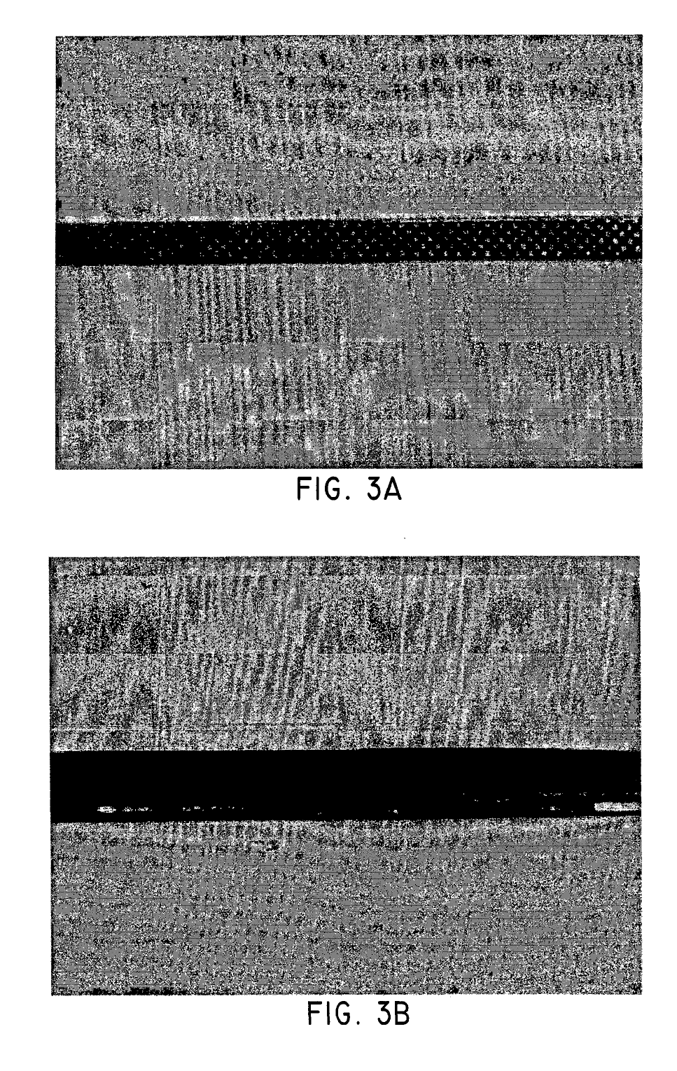

A strip of carbon fiber reinforced polymer (CFRP) sample having a size of 330 mm×10 mm×3 mm was taken and connected to two electrodes of an electrical circuit. The current of the electrical circuit was controlled at 14 A by a low voltage regulator, and the corresponding voltage was 10V. The treatment time was 15 minutes. It can be seen, by comparing the sample before treatment (FIG. 3A) and after treatment (FIG. 3B) that the carbon fibers had fully delaminated from the resin and substantially maintained a well-ordered arrangement after the treatment. The carbon fibers after the treatment also showed a substantially smooth surface. This example showed that the method disclosed herein can be used to efficiently and quickly to recover carbon fibers that is well-ordered, substantially free of defects and substantially free of residual resin. The example also showed that the carbon fiber can be recovered from the CFRP sample without other additional steps such as contacting the CFRP sample with solvents, mechanical shearing or chopping the CFRP sample, or applying external heating to the CFRP sample.

### Example 2

### Recovering Carbon Fibers Using Treatment With 12 V Voltage and 15 A Current for 5 Minutes

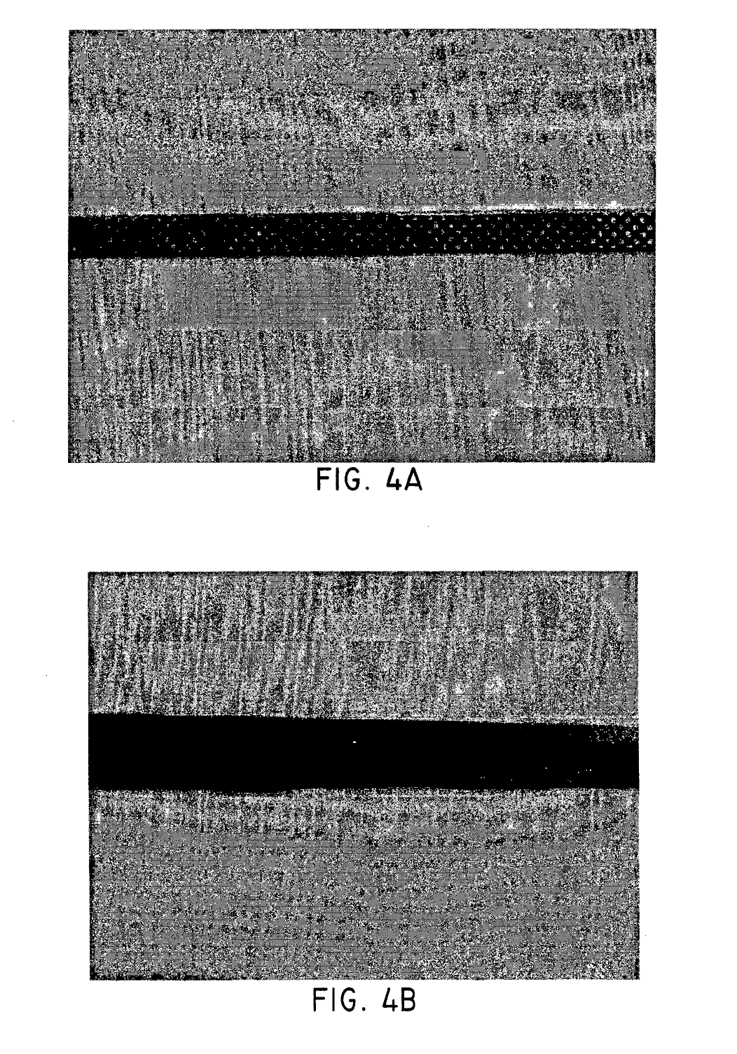

A strip of CFRP sample having a size of about 360 mm×10 mm×3 mm was taken and connected to two electrodes of an electrical circuit. The voltage was controlled at 12 V by a low voltage regulator to obtain a current of 15A, and the treatment time was 5 minutes. It can be seen, by comparing the sample before treatment (FIG. 4A) and after treatment (FIG. 4B) that the carbon fibers had fully delaminated from the resin after the treatment, and substantially maintained a well-ordered arrangement after the treatment. The carbon fibers after the treatment also showed a substantially smooth surface. This example showed that the method disclosed herein can be used to efficiently and quickly to recover carbon fibers that is well-ordered, substantially free of defects and substantially free of residual resin. The example also showed that the carbon fiber can be recovered from the CFRP sample without other additional steps such as contacting the CFRP sample with solvents, mechanical shearing or chopping the CFRP sample, or applying external heating to the CFRP sample.

### Example 3

### Recovering Carbon Fibers Using Treatment With 10 V Voltage and 17 A Current for 30 Minutes

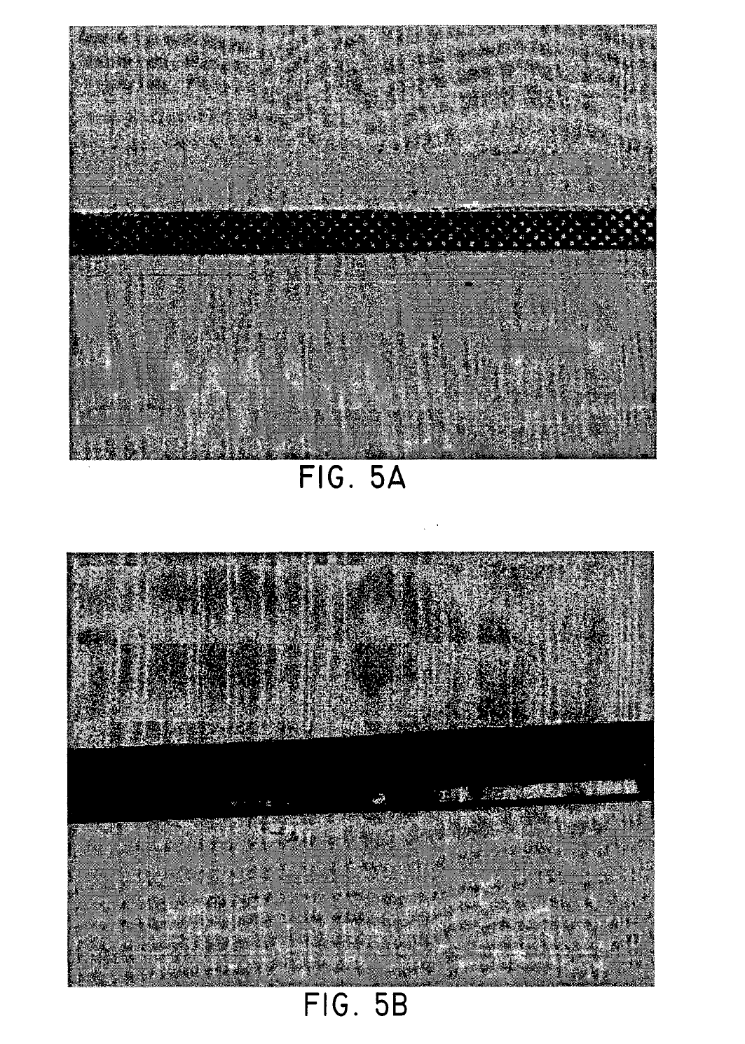

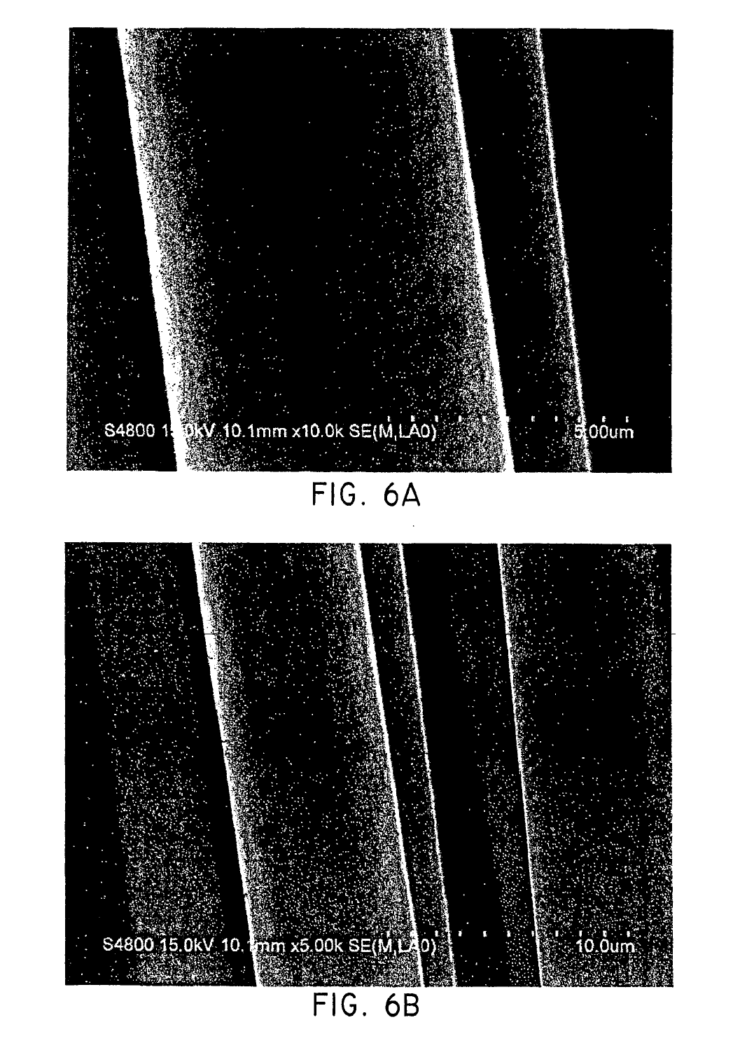

A strip of CFRP sample having a size of about 300 mm×10 mm×3 mm was taken and connected to two electrodes of an electrical circuit. The voltage was controlled at 10 V by a low voltage regulator, and the corresponding current was 17 A. The treatment time was 30 minutes. Carbon fibers with epoxy resin removed was thus recovered. Digital photographs of the sample before (FIG. 5A) and after treatment (FIG. 5B) are shown, from which it can be seen that the carbon fibers were delaminated from the resin and substantially maintained a well-ordered arrangement. SEM images of the carbon fibers are shown in FIGS. 6A-B, from which it can be seen that the carbon fiber filaments were completely separated with very smooth surface and without any residual polymer or obvious damage. This example showed that the method disclosed herein can be used to efficiently and quickly recover carbon fibers with good quality (well-ordered, free of defects and without residual resin) from carbon fiber reinforced resin. The example also showed that the carbon fiber can be recovered from the CFRP sample without other additional steps such as contacting the CFRP sample with solvents, mechanical shearing or chopping the CFRP sample, or applying external heating to the CFRP sample.

With respect to the use of substantially any plural and/or singular terms herein, those having skill in the art can translate from the plural to the singular and/or from the singular to volume of wastewater can be received in the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (for example, “ a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (for example, “ a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible sub-ranges and combinations of sub-ranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into sub-ranges as discussed above. Finally, as will be understood by one skilled in the art, a range includes each individual member. Thus, for example, a group having 1-3 articles refers to groups having 1, 2, or 3 articles. Similarly, a group having 1-5 articles refers to groups having 1, 2, 3, 4, or 5 articles, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

1. A method of recovering carbon fibers from at least one object, the method comprising:
providing at least one object comprising carbon fibers and resin; and
applying an electrical current to the at least one object to separate the carbon fibers from the resin.

2. (canceled)

3. (canceled)

4. The method of claim 1, wherein the electrical current is provided by an electrical circuit.

5. (canceled)

6. (canceled)

7. The method of claim 4, wherein the electrical circuit comprises at least two electrodes that are connected to at least two contact points on the object.

8. (canceled)

9. (canceled)

10. The method of claim 1, wherein applying an electric current to the at least one object generates heat within the at least one object.

11. (canceled)

12. (canceled)

13. The method of claim 10, wherein the heat is evenly distributed within the at least one object.

14. The method of claim 1, wherein no heat is applied to the at least one object from an external source.

15-18. (canceled)

19. The method of claim 1, wherein the at least one object has a thickness of about 1 mm to about 3 mm.

20. The method of claim 1, wherein applying the electric current to the at least one object comprises applying a voltage of about 4 V to about 12 V across at least two contact points on the at least one object.

21. The method of claim 1, wherein the electric current has a current of about 14 A to about 20 A.

22. (canceled)

23. (canceled)

24. The method of claim 1, wherein applying the electric current to the at least one object comprises supplying a power of about 50 W to about 200 W to an electrical circuit in electrical communication with the at least one object.

25. The method of claim 10, wherein the electric current heats the at least one object to a temperature of about 320° C. to about 560° C.

26. The method of claim 10, wherein the electric current heats the at least one object for about 1 minute to about 30 minutes.

27. The method of claim 10, wherein the electric current heats the at least one object for less than or equal to about 5 minutes.

28. (canceled)

29. The method of claim 10, wherein the electric current heats the at least one object until the resin has been completely separated from the carbon fibers.

30. (canceled)

31. The method of claim 1, wherein the carbon fibers substantially maintain an original order of arrangement of the carbon fibers after the applying step.

32. The method of claim 1, wherein applying the electric current to the at least one object is performed in the absence of one or more solvents.

33. The method of claim 1, wherein applying the electric current to the at least one object is performed in the absence of one or both of mechanical shearing and chopping.

34. The method of claim 1, further comprising removing the resin by hot airflow.

35. The method of claim 1, wherein the resin comprises an epoxy resin.

36. The method of claim 1, further comprising recovering the separated carbon fibers.

37. A system for recovering carbon fibers from at least one object, the system comprising:
an electrical circuit configured to apply an electric current to the at least one object, the at least one object comprising carbon fibers and resin, wherein the electric current separates the carbon fibers from the resin; and
at least one device configured to remove the carbon fibers that are separated from the resin.

38. The system of claim 37, wherein the electrical circuit comprises at least two electrodes configured to electrically connect to at least two contact points on the at least one object.

39. The system of claim 37, wherein the electrical circuit comprises a power source.

40. The system of claim 37, wherein the electrical circuit comprises a voltage regulator.

41. The system of claim 40, wherein the voltage regulator is a low voltage regulator.

42-45. (canceled)

46. The system of claim 37, wherein the electrical circuit is configured to apply a voltage of about 4 V to about 12 V across at least two contact points on the at least one object.

47. The system of claim 37, wherein the electric current has a current of about 14 A to about 20 A.

48. (canceled)

49. (canceled)

50. The system of claim 37, wherein the electrical circuit is configured to operate at a power of about 50 W to about 200 W.

51. The system of claim 37, wherein the electric current is configured to heat the at least one object to a temperature of about 320° C. to about 560° C.

52. A method of recovering carbon fibers from at least one object, the method comprising:
providing at least one object comprising carbon fibers and resin;
applying an electrical current of about 12 A to about 200 A to the at least one object to separate the carbon fibers from the resin;
removing the resin from the at least one object; and
recovering the separated carbon fibers.
